(19) United States
(12) Patent Application Publication
(10) Pub. No.: US 2016/0337558 A1
(43) Pub. Date: Nov. 17, 2016

(54) FOLDABLE ELECTRIC DEVICE

(71) Applicant: QUANTA COMPUTER INC., Taoyuan City (TW)

(72) Inventors: Yun-Cheng LIU, New Taipei City (TW); Wan-Chi LIN, Taichung City (TW); Ching-Hsien LIN, Taoyuan City (TW)

(73) Assignee: QUANTA COMPUTER INC., Taoyuan City (TW)

(21) Appl. No.: 14/807,614

(22) Filed: Jul. 23, 2015

(30) Foreign Application Priority Data
May 11, 2015 (TW) 104114916

(51) Int. Cl. H04N 5/225; G06F 3/02; G06K 9/00

(52) U.S. Cl. CPC H04N 5/2251; G06K 9/00013; G06F 3/0202

(57) ABSTRACT

A foldable electric device includes an upper member, a lower member, a fingerprint recognition module, a sensing unit, a control unit, and a power unit. The upper member and the lower member are pivoted with each other. The fingerprint recognition module is positioned on the upper member. The sensing unit is responsive to a motion of flipping the upper member so as to generate an enabling signal. The power unit distributes power to the control unit and the power unit according to the enabling signal, so that the control unit can compare the fingerprint characteristic information with the preloaded fingerprint data when the fingerprint recognition module captures fingerprint characteristic information. When the fingerprint characteristic information and the preloaded fingerprint data are matched, the control unit notifies an operating system to execute a boot process, and the fingerprint characteristic information serves as a basis for logging in the operating system.

### RELATED APPLICATION LICATIONS

This application claims priority to Taiwan Application Serial Number 104114916, filed May 11, 2015, which is herein incorporated by reference.

### BACKGROUND

1. Field of Invention

The present invention relates to an electronic device. More particularly, the present invention relates to a foldable electronic device.

2. Description of Related Art

Generally, the booting function of the notebook depends on an individual power button. After the user flipping open the display, he/she has to press the power button, waits for the completion of booting and then enters the account identification and password for logging-in. However, the above-mentioned process is quite minute and complicated, resulting in poor user experience.

In view of the foregoing, there exist problems and disadvantages in the related art for further improvement of the user experience.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one aspect, the present disclosure provides a foldable electronic device that solves the afore-mentioned technical problem(s) in the prior art.

In one embodiment, the foldable electronic device comprises an upper member, a lower member, a fingerprint recognition module, a sensing unit, a control unit and a power unit. The upper member is pivoted with the lower member, the fingerprint recognition module is positioned on upper member, and the control unit is electrically connected to fingerprint recognition module. The sensing unit is responsive to a motion of flipping open the upper member so as to generate an enabling signal. The power unit is configured to distribute power to the control unit and the fingerprint recognition module according to the enabling signal, and when the fingerprint recognition module captures fingerprint characteristic information, the control unit compares the fingerprint characteristic information with a preloaded fingerprint data, and if the fingerprint characteristic information and the preloaded fingerprint data are matched, the control unit is configured to notify an operating system to execute a boot process, and the fingerprint characteristic information serves as a basis for logging in the operating system.

In view of the foregoing, the present disclosure starts with the aim of enhancing user experience, so that the user can accomplish the booting and logging-in functions with a simple action of flipping open an upper member (such as, the display) without the otherwise minute and complicated operating procedure.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1A is a three-dimensional view of a foldable electronic device according to one embodiment of the present disclosure;

FIG. 1B is a diagram illustrating the foldable electronic device of FIG. 1A in an operation condition; and

FIG. 2 is a block diagram illustrating a foldable electronic device according to one embodiment of the present disclosure.

### DETAILED DESCRIPTION

In the following detailed description, for purposes of explanation, numerous specific details are set forth in order to attain a thorough understanding of the disclosed embodiments. In accordance with common practice, like reference numerals and designations in the various drawings are used to indicate like elements/parts. Moreover, well-known elements or method steps are schematically shown or omitted in order to simplify the drawing and to avoid unnecessary limitation to the claimed invention.

As used herein, the terms “first,” “second,” . . . etc. do not intend to dictate a specific order or sequence, and are not used to limit the present disclosure; these terms are merely used to distinguishes elements or operations that are described using the same technical term.

Generally, in the present disclosure, the term “about,” “approximately,” or “around” means within 20% of a given value or range; preferably, within 10%; more preferably, within 5%. Unless otherwise expressly specified in the present disclosure, all of the numerical ranges, amounts, values, and percentages disclosed herein should be understood as modified in all instances by the term “about,” “approximately,” or “around.”

Throughout the present specification and the annexed claims, the terms “couple” or “connect” refer to the cases where two or more components are in physical contact or electric contact, either directly or indirectly with one another; or two or more components operate or interact on/with one another.

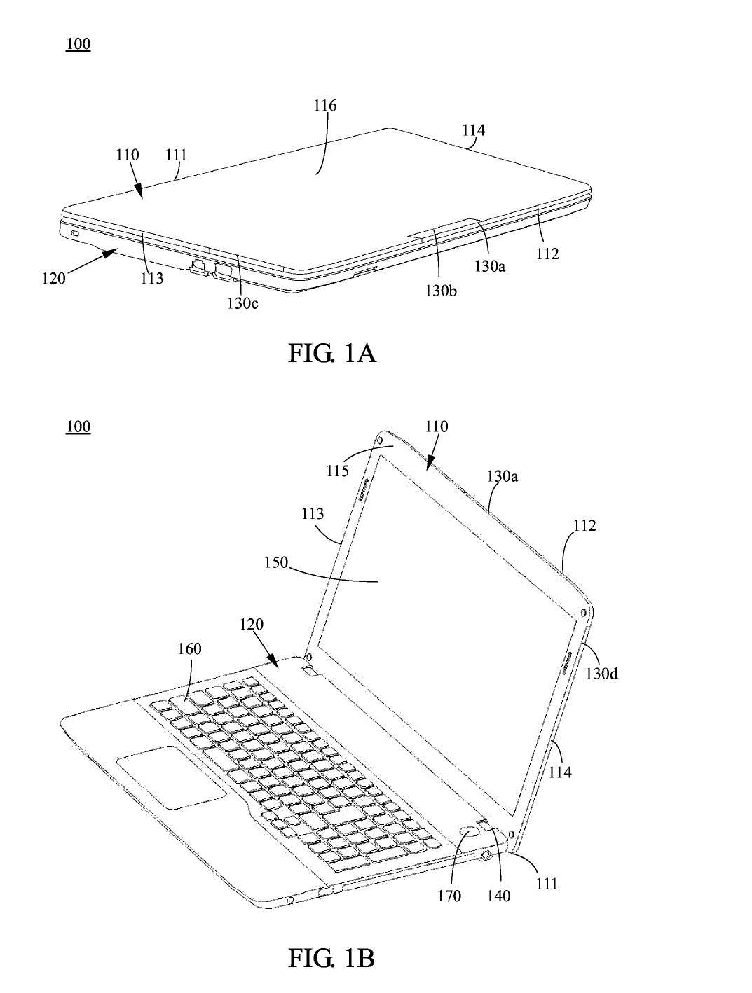

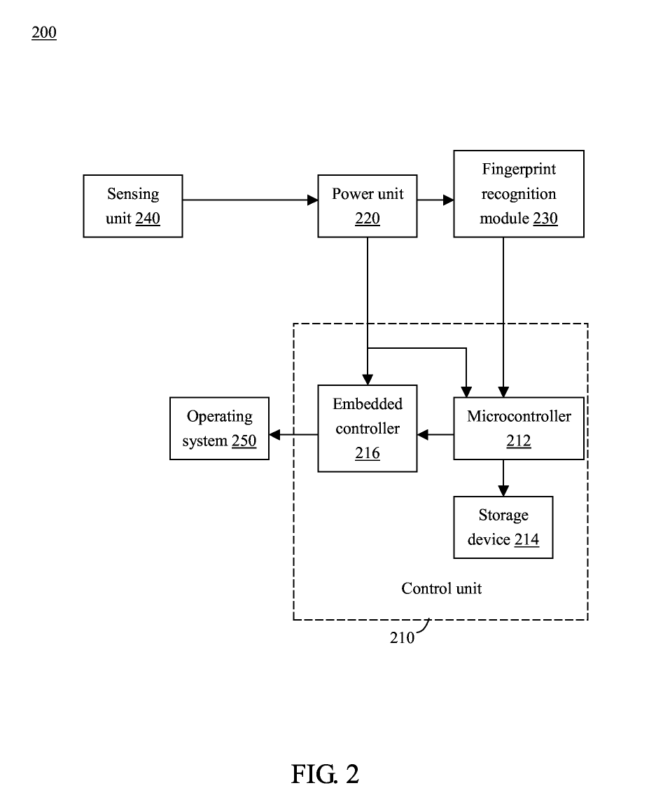

One technical aspect of the present disclosure is directed to a foldable electronic device, which may be a notebook, portable device, mobile phone or wildly applied in various electronic products. It should be noted that the foldable electronic device according to the present technical aspect allows the user to accomplish the booting and logging-in functions with a simple action of flipping open the cover. The implementation of the present foldable electronic device is described below in connection with FIG. 1A to FIG. 2.

FIG. 1A is a three-dimensional view of a foldable electronic device 100 according to one embodiment of the present disclosure, and FIG. 1B is a diagram illustrating the foldable electronic device 100 in an operation condition. The above-mentioned foldable electronic device 100 may be, for example, a notebook that comprises an upper member 110, a lower member 120, fingerprint recognition modules 130a, 130b, 130c, 130d, and a sensing unit 140. The display 150 of the notebook is disposed and can be seen on a first surface 115 of the upper member 110, the second surface 116 of the upper member 110 is opposite to the first surface 115, and a casing is disposed on the second surface 116. The host of the notebook is installed at the lower member 120, and the host is equipped with a keyboard 160.

In one embodiment, the foldable electronic device 100 is disposed with at least one fingerprint recognition module.

The fingerprint recognition modules 130a, 130b, 130c, 130d are positioned on the upper member 110. The upper member 110 is pivoted with the lower member 120, so that the upper member 110 can be rotatably connected to the lower member 120. When the user lifts or flips open the upper member 110, the sensing unit 140 is configured to sense the motion of flipping the upper member 110, and allow the host to execute the boot process; if, during the process of flipping open the upper member 110, the user presses or touches any one of the fingerprint recognition modules 130a, 130b, 130c, 130d, the user is automatically logged into an operating system (such as, Microsoft Windows operating system, Android system, . . . , etc.); that is, using the fingerprint recognition module to capture the user's fingerprint, which replaces the conventional practice of using the account identification and password inputted by the user for logging into the operating system. In this way, the user may accomplish the booting and logging-in functions with a simple action of lifting up the upper member 110, rather than by lifting up the upper member 110 followed by pressing the power button 170 for starting up the electronic device and then entering the account identification and password for logging in using the keyboard 160.

In one embodiment, when the user lifts up the upper member 110, the sensing unit 140 senses the motion of flipping the upper member 110, and notifies the power unit 220 (see, FIG. 2) to supply power to the fingerprint recognition module 230. At this time, if the user presses or touches any one of the fingerprint recognition module 130a, 130b, 130c, 130d while flipping up the upper member 110, the host is configured to be turned on and automatically log into the operating system.

In one embodiment, the power button 170 and the fingerprint recognition module are integrated in a single module; hence, when the user presses/touches the fingerprint recognition module, the host is turned on simultaneously (since the power button 170 is pressed), and automatically logs into the operating system (since the fingerprint recognition module is pressed).

In various embodiments, the fingerprint recognition modules 130a, 130b, 130c, 130d are disposed at positions that is ready to be touched easily by the user's finger(s) while the user flips open the upper member 110. For example, the user may touch the lateral side of the upper member 110, so as to facilitate the action of flipping open the upper member 110. Regarding the structure of the lateral side, the upper member 110 has a first lateral side 111, a second lateral side 112, a third lateral side 113, and a fourth lateral side 114. The first lateral side 111 and the second lateral side 112 are opposite to each other, while the third lateral side 113 and the fourth lateral side 114 are opposite to each other and connected to the first lateral side 111 and the second lateral side 112. Moreover, the oppositely disposed first and second surfaces 115 and 116 adjoin with the first, second, third, and fourth lateral sides 111, 112, 113, and 114.

The upper member 110 is pivoted with the lower member 120 at the first lateral side 111, the fingerprint recognition module 130a is positioned on the second lateral side 112 of the upper member 110 (as illustrated in FIG. 1A), which is in line with a general user's habit of flipping open the display 150 from the second lateral side 112. More specifically, the fingerprint recognition module 130a is positioned on the central region of the second lateral side 112, so that during real-life operation, the user feels more comfortable to lift up the upper member from the central region of the second lateral side 112. As to the ratio of the fingerprint recognition module 130a to the second lateral side 112 in length, it can be adjusted by persons having ordinary skills in the art depending the types of electronic devices.

When the user flips open the upper member along the central region of the second lateral side 112, it is possible that the user touches the second surface 116 of the upper member 110. In view of this, as illustrated in FIG. 1A, the fingerprint recognition module 130b is positioned on upper member 110 of the second surface 116 and immediately in close proximity to the central region of the second lateral side 112, so as to conform to the user's common operating behavior.

On the other hand, the user may lift up the upper member 10 along the third lateral side 113 or the fourth lateral side 114. Hence, as illustrated in FIG. 1A, the fingerprint recognition module 130c is positioned on the third lateral side 113 of the upper member 110, and the distance between the fingerprint recognition module 130c and the second lateral side 112 is smaller than the distance between the fingerprint recognition module 130c and the first lateral side 111, so that the fingerprint recognition module 130c is positioned at a location on the third lateral side 113 that is relatively remote from the pivot connecting the upper and lower members 110 and 120, thereby facilitating the user in lifting up the upper member 110 by saving the effort.

Similarly, as illustrated in FIG. 1B, the fingerprint recognition module 130d is positioned on the fourth lateral side 114 the upper member 110, and the distance between the fingerprint recognition module 130d and the second lateral side 112 is less than the distance between the fingerprint recognition module 130d and the first lateral side 111, so that the fingerprint recognition module 130d is positioned at a location on the fourth lateral side 114 that is relatively remote from the pivot connecting the upper and lower members 110 and 120, thereby facilitating the user in lifting up the upper member 110 by saving the effort.

In practice, the fingerprint recognition modules 130a, 130b, 130c, and 130d can be a capacitive fingerprint recognition sensor, optical fingerprint recognition sensor, or any other fingerprint recognition sensor. As could be appreciated, although four fingerprint recognition modules 130a, 130b, 130c, and 130d are illustrated in FIGS. 1A and 1B, the present invention is not limited to such quantity. In practice, the fingerprint recognition modules 130a, 130b, 130c, and 130d can be integrated into a single fingerprint recognition module or split into more fingerprint recognition modules; alternatively, one or more fingerprint recognition modules may be omitted or added; any of the above modifications remain within the scope of the present invention, and persons having ordinary skill in the art may flexibly select a suitable number of fingerprint recognition module(s) depending on the actual need.

As illustrated in FIG. 1B, the sensing unit 140 is a switch; such as a lid switch, a magnetic switch, a button, etc.; such switch is linked with the upper member 110, such that when the upper member 110 is flipped open, the switch is caused to send out an enabling signal, so that the host automatically performs the boot process; in this way, the user is not required to press the power button 170 for turning on the device after he/she flips open the upper member 110. More specifically, in various embodiments, when the upper member 110 is flipped open, the switch is subject to an action similar to “poking,” “pressing,” or “pushing,” thereby sending out a high-level or low-level signal as the power enabling signal so that the power unit of the host provides the power for turning on the device.

To further elaborate the system infrastructure of the above-mentioned foldable electronic device, reference is directed to FIG. 2; FIG. 2 is a block diagram illustrating a foldable electronic device 200 according to one embodiment of the present disclosure. As illustrated in FIG. 2, the foldable electronic device 100 comprises a control unit 210, a power unit 220, a fingerprint recognition module 230, and a sensing unit 240. Structurally, the sensing unit 240 is electrically connected to the power unit 220, and the power unit 220 is electrically connected to the control unit 210 and the fingerprint recognition module 230.

The fingerprint recognition module 230 can be any of the fingerprint recognition modules 130a, 130b, 130c, and 130d illustrated in FIG. 1A and FIG. 1B, or any combination thereof; the sensing unit 240 is basically identical to the sensing unit 140 in FIG. 1B, which is responsive to a motion of flipping the upper member 110 so as to generate an enabling signal to notify the power unit 220. The power unit 220 distributes power to at least the control unit 210 and the power unit 230 according to the enabling signal. If, during the process of clipping open the upper member, the user touches/presses the fingerprint recognition module 230, the fingerprint recognition module 230 is configured to scan the user's fingerprint, so that when the fingerprint recognition module 230 captures the user's fingerprint characteristic information, the control unit 210 is configured to compare the fingerprint characteristic information with a preloaded fingerprint data. If the fingerprint characteristic information and the preloaded fingerprint data are matched, the control unit 210 would notify the operating system 250 to execute the boot process, and the fingerprint characteristic information serves as a basis for logging into the operating system 250. In this way, the user may perform a simple action of flipping open the cover to cause the foldable electronic device 200 to automatically turn on the device and log into the operating system 250.

In one embodiment, as illustrated in FIG. 2, the control unit 210 comprises a microcontroller 212, a storage device 214 (such as a memory), and an embedded controller 216. Structurally, the power unit 220 is electrically connected to the microcontroller 212 and the embedded controller 216, the microcontroller 212 is electrically connected to the storage device 214, and the embedded controller 216 is electrically connected to the microcontroller 212.

In one embodiment, the microcontroller 212 and the embedded controller 216 may be integrated as a single processor.

The foldable electronic device 200 allows the user to set one or more fingerprint(s) for substituting the account identification and password in advanced; during the setting process, the user may touches the fingerprint recognition module 230, so that the microcontroller 212 reads the fingerprint data captured by the fingerprint recognition module 230 and preloads said fingerprint data into the storage device 214, so that the storage device 214 stores this preloaded fingerprint data. After the completion of the above-mentioned setting process, whenever the user touches the fingerprint recognition module 230 while flipping open the upper member, the fingerprint recognition module 230 can scan the user's fingerprint and the microcontroller 212 compares the fingerprint characteristic information with the preloaded fingerprint data. When the fingerprint characteristic information matches the preloaded fingerprint data, the microcontroller 212 generates a recognition-correct signal, and sends this recognition-correct signal to the embedded controller 216. The embedded controller 216, after receiving said recognition-correct signal, notifies the operating system 250 to execute the boot process.

In operation, after the microcontroller 212 is supplied with the power, it first detects and reads the fingerprint characteristic information in the fingerprint recognition module 230, and then compares said fingerprint characteristic information with the preloaded fingerprint data in the storage device 214. When the microcontroller 212 determines that the fingerprint characteristic information of the fingerprint recognition module 230 matches the preloaded fingerprint data in the storage device 214, the microcontroller 212 communicates with the embedded controller 216 via a transmission interface. The embedded controller 216, after receiving the recognition-correct signal sent from the microcontroller 212, notifies the operating system 250 to run the boot process; during this stage, the operating system 250 starts to take charge of process until the boot process is completed.

In practice, in addition to the infrastructure provided in FIG. 2, the control unit 210 can be implemented by any suitable software, hardware, and/or firmware. For example, if an implementer determines that speed and accuracy are paramount, the implementer may opt for a mainly hardware and/or firmware implementation for the control unit 210; if flexibility is paramount, the implementer may opt for a mainly software implementation for the control unit 210; alternatively, the collaboration of software, hardware and firmware may be adopted for the control unit 210. It should be noted that none of the above-mentioned examples is inherently superior to the other and shall be considered limiting to the scope of the in present invention; rather, these examples can be utilized depending upon the context in which the control unit 210 will be deployed and the specific concerns of the implementer.

In view of the foregoing, the present disclosure starts with the aim of enhancing user experience, so that the user can accomplish the booting and logging-in functions with a simple action of flipping open the cover without the otherwise minute and complicated operating procedure.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. A foldable electronic device, comprising,
an upper member;
a lower member pivoted with the upper member;
a fingerprint recognition module positioned on the upper member;
a control unit electrically connected to the fingerprint recognition module;
a sensing unit responsive to a motion of flipping the upper member, so as to generate an enabling signal; and
a power unit configured to distribute power to the control unit and the fingerprint recognition module according to the enabling signal, wherein when the fingerprint recognition module captures a fingerprint characteristic information, the control unit compares the fingerprint characteristic information with a preloaded fingerprint data, and if the fingerprint characteristic information and the preloaded fingerprint data are matched, the control unit notifies an operating system to execute a boot process, and the fingerprint characteristic information serves as a basis for logging in the operating system.

2. The foldable electronic device according to the claim 1, wherein the control unit comprises:
a storage device, configured to store the preloaded fingerprint data;
a microcontroller, electrically connected to the fingerprint recognition module, and configured to compare the fingerprint characteristic information with the preloaded fingerprint data, so that when the fingerprint characteristic information and the preloaded fingerprint data are matched, the microcontroller generates a recognition-correct signal; and
an embedded controller configured to notify the operating system to execute the boot process after the embedded controller received the recognition-correct signal.

3. The foldable electronic device according to the claim 1, wherein the sensing unit is a switch, wherein the switch is responsive with the upper member, so that when the upper member is lifted up, the switch sends out the enabling signal.

4. The foldable electronic device according to the claim 3, wherein the switch is a lid switch.

5. The foldable electronic device according to the claim 1, wherein the upper member has a first lateral side and a second lateral side that are opposite to each other, and the upper member is pivoted with the lower member at the first lateral side, while the fingerprint recognition module is positioned at the second lateral side of the upper member.

6. The foldable electronic device according to the claim 5, wherein the fingerprint recognition module is positioned at the central region of the second lateral side.

7. The foldable electronic device according to the claim 1, wherein the upper member has a first lateral side, a second lateral side, a third lateral side and a fourth lateral side, in which the first and second lateral sides are opposite to each other, the upper member is pivoted with the lower member at the first lateral side, the third and fourth lateral sides are opposite to each other and connects with the first and second lateral sides, the fingerprint recognition module is positioned on at least one of the third and fourth lateral sides, and the distance between the fingerprint recognition module and the second lateral side is smaller than the distance between the fingerprint recognition module and the first lateral side.

8. The foldable electronic device according to the claim 1, wherein the upper member has a first surface, a second surface, a first lateral side and a second lateral side, in which the first and second surfaces are opposite to each other, and when the upper and lower members are flipped close, the first surface faces the lower member, the first and second lateral sides are opposite to each other and adjoins the first and second surface, the upper member is pivoted with the lower member at the first lateral side, and the fingerprint recognition module is positioned on the second surface and in close proximity to the central region of the second lateral side.

9. The foldable electronic device according to the claim 1, wherein the upper member comprises a display, and the lower member comprises a host, wherein the host has a keyboard.

10. The foldable electronic device according to the claim 1, wherein the foldable electronic device is a notebook or a mobile phone.
